(19) United States
(12) Patent Application Publication
(10) Pub. No.: US 2012/0169065 A1
(43) Pub. Date: Jul. 5, 2012

(54) Home energy systems

(76) Inventors: Lambertus Hesselink, Atherton, CA (US); James Gibbons, Portola, CA (US)

(21) Appl. No.: 13/136,168

(22) Filed: Jul. 26, 2011

Related U.S. Application Data
(60) Provisional application No. 61/400,541, filed on Jul. 28, 2010.

(51) Int. Cl. H02K 7/18

(52) U.S. Cl. 290/1 R

(57) ABSTRACT

An energy system is provided that includes an engine disposed to produce electricity, a fuel storage disposed to hold fuel for use by the engine, a battery disposed to store the electricity produced by the engine, an electrical grid having electrical connectivity of a charging station from the engine or the battery, and an electrical grid controller disposed to regulate the generation, use and delivery of the electricity to and from the electrical grid.

### CROSS-REFERENCE TO RELATED APPLICATIONS

This application claims priority from US Provisional Patent Application 61/400541 filed Jul. 28, 2010, which is incorporated herein by reference.

### FIELD OF THE INVENTION

The present invention relates generally to energy systems. More particularly, the invention relates to a self-contained home energy eco system that uses natural gas and renewable energy as its sources of energy.

### SUMMARY OF THE INVENTION

To address the needs in the art, an energy system is provided that includes an engine disposed to produce electricity, a fuel storage disposed to hold fuel for use by the engine, a battery disposed to store the electricity produced by the engine, an electrical grid having electrical connectivity of a charging station from the engine or the battery, and an electrical grid controller disposed to regulate the generation, use and delivery of the electricity to and from the electrical grid.

### DETAILED DESCRIPTION

Consider an electrical car with a 160 HP engine and a 16 kW-h battery bank, which provides a range of approximately 40 miles per charging, and a conventional gas engine has typically 71 HP to extend the range. From a consumer behavioral perspective, an electric car is believed to provide the same range and benefits as a conventional internal combustion engine, at the same cost plus additional benefits to change behavior, i.e. to induce consumers to switch from an internal combustion (IC) engine to an electric engine.

From an analysis of the US energy flow it becomes clear that major inefficiencies are present that significantly influence energy management and waste in the US and around the world. Considering energy generation, residential energy consumption, industrial energy consumption and transportation, then it becomes evident that transportation and energy distribution are the least efficient while being the largest in terms of energy consumption as shown in Table 1.

TABLE 1
US Energy flow priorities

| | TOTAL | | |
|---|---|---|---|
| | AMOUNT | | 10% INCREASE |
| TYPE | EXAJOLES | EFFICIENCY | IN EFFICEINCY |
| Energy | 36.3 | 31.9% | 3.6 |
| generation | | | |
| Residential | 19.3 | 75.1% | 1.9 |
| Industrial | 23.6 | 79.6% | 2.3 |
| Transportation | 27.3 | 20.1% | 2.7 |

The invention provides an ecosystem of home devices to produce electricity for transportation, hot water for domestic use and heating, electricity off-the-grid, and for compressing natural gas to compressed natural gas for transportation. Electricity is produced by either internal combustion (IC) engines adapted to run on a variety of fuels such as natural gas, biogas, and gasoline, or by a modular (solid state or system with no moving parts) Stirling engine that uses external heat sources, such as natural gas, solar thermal heating, bio fuels, and others. The Stirling engine is mass-produced through modular design allowing customers to size their units based on need and to reduce cost. The home contains a liquefied natural gas (LNG) or compressed natural gas (CNG) storage tank, typically 20 gallons for home emergency use and for transportation in case the gas supply is interrupted. Under normal circumstances the generator runs on low-pressure gas, and the reserve tank is connected to the generator via a pressure control valve. Local batteries may be used for providing electricity, charged by either renewable energy sources or a CNG generator. The charging engine can be small compared to a car engine and delivers energy on an as-needed basis through a control system similar to a speed control device used in cars. A smart grid connects charging stations, home charging stations, and regulates the generation, use and delivery of electricity for domestic use and or to connect it back into the grid.

The invention is a self-contained home energy ecosystem that uses natural gas and renewable energy as its sources of energy. In one aspect the invention can produce local energy from renewable sources, additionally natural gas can provide a cleaner alternative to the current energy sources such as coal and gas. A further aspect of the invention is to store sufficient natural gas in a compressed form to supply transportation and home energy needs during a period when both electric and gas power are unavailable from the local utility and from renewable sources such as local wind, solar, and hydro-electric. In one aspect, the invention can use photothermal energy generation based on a novel Stirling engine system.

Based on the data in Table 1, it is evident that the largest impact in US and world energy consumption and environment impact would be to generate energy locally near or at the home, and replace cars with internal combustion engines with electrical propulsion systems. Electrical propulsion systems generate about 20% heat while 80% of the energy directly affects propulsion, while for internal combustion engines the numbers are approximately reversed.

Table 1 also shows that residential and industrial energy consumption are much more efficient than propulsion and energy generation and therefore present a lesser opportunity for improved energy efficiency.

Additionally energy efficiency and environmental concerns point the way towards achieving a sustainable energy eco-system, utilizing renewable environmentally friendly energy sources. In terms of energy density, solar, wind and hydro-electric energy generation are increasingly more efficient when comparing energy per unit of mass. Although solar energy is widely available and most abundant of all renewable energy sources, and in principle could be used to generate all of the world's energy needs from a land area smaller than the size of the state of New Mexico, this would still not address inefficiencies in energy transmission and the need for electrical energy storage.

The invention is eco system of energy devices and modes of transportation that address the fundamental problems of energy flow in the US and around the world. The eco-system revolves around energy generation at the point of need, for example the home, coupled to efficient electrical propulsion systems. Additionally energy would be supplied to the vehicles using a smart grid approach. In one embodiment of the invention the smart grid allows users to make decisions on the basis of economic as well as energy availability factors in a dynamic market place environment. For instance, data is collected from web sites on such things as spot prices for electricity and gas, for example, and perhaps short term weather forecasts, such as sun or wind, which would then be used to choose the amount of energy derived from each of the resources to create a minimum daily or weekly energy cost with user-specified constraints (e.g., prioritization of loads in periods of extreme energy shortage). Making a system that gives each user daily information on costs is one feature.

The current invention provides an eco-system solution that significantly improves energy efficiency and reduces the carbon footprint substantially. The invention addresses the need for increased efficiency in the nations energy consumption, generation and transport. Transportation and Energy generation and transport are the least efficient in the total energy flow in the US, as shown in Table 1. The invention addresses both the problem of increasing energy efficiency in these areas, as well as reduction in the carbon footprint to create and use this energy. The invention uses common infrastructure in the US and around the world to heat homes with natural and propane gas. Almost every home in the US and the Western World has a gas line attached to the home for water and space heating. The invention uses this source of clean energy to generate local electricity. This is done initially through the use of an IC engine adapted to the use of natural or propane gas, while a more sustainable solution is provided in another aspect, which involves the use of solar thermal heating for the generation of hot water and space heating. The high temperature reservoir can be used to provide a temperature bath for a Stirling engine that can be run between the high temperature reservoir and room or ground temperature around 4° C. through a pipe into the ground. Heat management may require a higher operating temperature so that heat can be removed efficiently from the Stirling cycle. Current Stirling engines are typically devised to produce vast amounts of energy on an industrial scale, but not at the 1-10 kW needed for domestic use. Solar thermal engines, however, are also useful as they make better use of solar energy than solar voltaic cells do, with typical total energy efficiency being at least twice as high, and often 3-4× higher. The efficiency of a Stirling engine is defined by the Carnot efficiency, and can reach values of 40-50% in practical applications. The system of the current invention uses either solar thermal energy or gas energy to create the high temperature bath needed for Stirling engine operation, or a combination of both when there is not sufficient solar power available. Ideally the Stirling engine is of a new solid state design, or a design with no moving parts to reduce mechanical failure and improve reliability and portability. Alternatively, connected mass produced Stirling engines using for example MEMS technology may be used.

At present hybrid cars use batteries for limited operation and range, while using IC engines as auxiliary propulsion systems. These cars obtain equivalent mpg in the range of about 50 mpg. The current invention reaches efficiencies of over 200 mpg by using an electric engine and a Stirling or gas operated generator to charge the batteries for large transport range exceeding 300 miles.

For consumer applications an electric and energy assisted electric car must provide the same benefits as conventional IC engine cars, but with better gas mileage and cleaner operating conditions reducing carbon footprint. This requires that the on-board batteries must be kept at a minimum, while providing clean means for charging the batteries for ranges exceeding typically 40 miles and ideally 200 miles or more. A Stirling engine must therefore be low cost to manufacture and provide adjustable quantities of power for battery charging and range extension.

The key elements of the system are shown in FIG. 1 of APPENDIX A. The electric car has a range, as an example, varying form 30-300 miles based on the vehicle weight, size, performance characteristics and other variables. An auxiliary engine provides electric power to augment the battery stack. In the proposed system the engine could be an IC engine, or a Stirling engine. In an early implementation of the system natural gas is used as the preferred energy source for its high energy density while having a lower carbon footprint compared to oil combustion. In one embodiment, a Stirling electrical generator uses a variety of fuels, including gas, methanol, diesel and bio-mass fuels.

In one aspect of the invention, a home battery pack is charged in a variety of ways that include a connection to the existing power grid, local solar, wind or hydraulic energy or a local Stirling electrical generator. In one embodiment a natural gas solution is provided. Natural gas is abundantly available in the US and elsewhere and it is starting to be used for cleaner transportation in the US and around the world. Natural gas is also available in most homes in the US and around the industrial world, for domestic space and water heating. The invention uses existing delivery infrastructure.

The benefits of using natural gas over gasoline for car and truck propulsion are:
Reduces carbon monoxide emissions 90%-97%
Reduces carbon dioxide emissions 25%
Reduces nitrogen oxide emissions 35%-60%
Potentially reduces non-methane hydrocarbon emissions 50%-75%
Emits fewer toxic and carcinogenic pollutants
Emits little or no particulate matter
Eliminates evaporative emissions

One implementation of this embodiment is shown in FIG. 2 of APPENDIX A. As shown, a commercially available gas compressor suitable for use in the home/garage is used to compress natural gas from the main pipeline pressure (typically 10 psi) to 3500 psi, this being the pressure that is typical for running a compressed natural gas (CNG) engine intended for use in a CNG automobile. The compressed gas is stored in a reserve tank that can be used to fill the tank of a natural gas vehicle (NGV) and/or drive a separate engine that runs on natural gas to create a source of mechanical power in the rotation of a drive shaft. The reserve tank is refilled automatically, being in effect “topped up” after every withdrawal.

To supply electric power to the home, and to provide charging energy for the batteries in a hybrid or pure electric car, the gas reserve is used to power a CNG engine. Such an engine can be designed to have an output power (expressed in horsepower) that is suitable for the electricity demands of the home and for the car if it has electric propulsion. Engines can be implemented to provide more or less horsepower for specific applications.

The shaft output of this engine is then coupled to an automatic transmission fitted with an automatic cruise control so that the output power is supplied at constant speed to the electric generator. This will enable the generator to supply electrical power at a constant frequency, nominally 60 Hertz, at an output voltage of 110 volts for this example.

A home being powered by the output of this generator can have variable power demands over the day. These will translate to variable output (or load) current demands at the 110 volt line voltage. The current required by the home at any given time is used to derive a control signal which will in turn drives the cruise control so that the output speed of the engine remains constant, independent of the load current required. This assures generation of a constant voltage output of 110 volts. It also provides a system of maximum efficiency in which the engine is producing only the power that is needed by the load at any instant.

According to the invention, the system makes a home independent of the electric grid and the major losses associated with transmission of electric energy over large distances.

The instantaneous power required by a home will vary depending on how many appliances are being used, the time of day and so on. Peak power in the range of 6-7 KW is typical for most homes. 10 KW represents a significant load above normal and therefore gives a margin of safety in electrical demand for the average home.

To generate 10 KW, assuming 100% efficient conversion of power from the motor to the electrical output, requires a motor output of 10 KW/746=13.4 horsepower, where 746 is the electrical power equivalent of 1 horsepower. For additional margin, one aspect of the invention uses a 15 horsepower engine. This is the output power required of the motor when the electrical current for the home is at its maximum of 10 KW/110 volts=90 amps. In the early morning hours, the load is likely standby power for some equipment and power for such appliances as refrigerators that tend to use constant power all day. The minimum power level may be in the range of perhaps 1 KW for several hours. This is equivalent to having the engine operate at 1.34 hp to give an electrical output of about 9 amps. To achieve this level of power control, the invention uses the instantaneous load current requirement to control the output power of the motor. The power control is achieved by deriving a signal from the load current, which is used to drive the cruise control mechanism thus keeping the motor speed constant.

To make the home have the smallest carbon footprint possible, the invention uses the cleanest burning fuel possible and does not use any electricity that is delivered after transmission over long distance transmission lines, where the loss can reach or exceed 60%. This home system invention therefore is able to create enough power to charge a fully electric car. Charging batteries in a hybrid car is less demanding, where the home with a 10 KW load and a fully electric car represents a capacity near the high end of the demand. Three charging options for such an automobile are described. A basic 110 Volt option requires a current of 15 amps for 30 hours to produce a full charge. The total energy used in this case is ˜50 KWh. A second, fast charging option uses 220 Volts at 70 amps for 4 hours, with a total energy use of 62 KWh.

Considering the fast charging option, so that the car can be fully charged overnight, home system is able to deliver 110 Volts at 140 amps for 4 hours. The power output of the engine therefore is 15.4 KW, requiring a 20 horsepower engine running for 4 hours. As the home itself is requiring only 1-2 hp in the early morning hours, the engine that drives the home during the day can also charge the car at night. Taking both demands together, an engine capable of producing about 25 horsepower is provided to serve all needs of the home and transportation system for an all-electric car.

If transportation is to be with an NGV rather than a fully electric car, a reserve tank is provided to have a size that is sufficient to refuel the car in the evening and also provide enough CNG to drive the home and car charging apparatus (in the event that there are two cars and the second one is all electric). Consider a fuel tank with a capacity of 5 gallons and an engine providing 70 hp for 4 hours, or about 25 hp for about 11 hours. A reserve tank capacity of 10-12 gallons of CNG is provided so that a 5 gallon portion for car refueling and 5-7 gallons for home energy demand, which includes car charging for an all-electric car. With restricted driving in times of emergency, including minimal use of all electric vehicles, a 10-12 gallon reserve capacity tank is capable of supplying a home with electric energy for several days. Consider a system that includes a working tank with 10 gallon capacity and a truly reserve tank with an additional 10 gallon capacity, a home could be independent of even its natural gas feed for times on the order of a week or more.

In another embodiment, the invention is an eco-system that uses natural gas for both compression of gas, for space heating and cooling and electrical energy generation at home provided by a Stirling engine.

According to the invention, the Stirling engine is powered by a variety of energy sources, including natural gas, propane gas, bio-gas, diesel fuel etc. In the one aspect, natural gas or propane gas is used to reduce the carbon footprint. A two-phase or three-phase Stirling engine is envisioned. Alternatively, a Stirling design using photoacoustic operating principles may be used, which design is attractive as it has no moving parts. The generating capacity is targeted for 1-5 KW electrical output. The thermo-acoustic Stirling engine can be mated to a linear movement generator or to a solid state piezo-electric type sensor that creates electrical energy from pressure waves. Such a system is attractive as it can have high conversion efficiency exceeding 60-70% at low operating frequencies to over 80-90% at higher operating frequencies. Additionally, a solid state energy conversion system is attractive for its high reliability and lack of required maintenance. One key aspect to the design is modularization allowing the Stirling engine to be used at home, in the electric car, and for auxiliary purposes. The engine is based on modules that can be mass-produced, and in combination provides a range of capacities. For example, a basic Stirling engine producing 1 KW can be combined into a unit that includes five 1 KW units for a total of 5KW of electrical energy generation.

The Stirling engine according to the invention is based on a novel approach to creating a base unit that can manufactured at low cost and used in bundles to provide any desired output capacity. By building the Stirling engine out of small units reliability is improved significantly and cost is reduced through mass manufacturing similar to what is being used today in the electronics industry. The Stirling engine is a micro device, based on using nano technology for heat exchange and solid-state electricity generation such as is possible with photothermionic materials. The Stirling engine uses silicon as a heat exchange medium as Silicon is an extremely good heat conductor. This approach reduces losses in the Stirling engine cycle. Other solid state approaches are contemplated as well. In another embodiment, the Stirling engine uses a photo-thermally created high temperature bath to power the Stirling generator and to use the heat for both domestic water heating and space heating.

Photo-thermal energy generation is significantly more efficient than photovoltaic electrical energy generation. Photon absorption and electricity generation is typically limited to 15-16% efficiency today, with an upper limit of around 30-35% using exotic materials and complex opto-mechanical designs.

Photo-thermal energy and electricity generation is fundamentally more efficient. Photon energy can be used to heat a suitable fluid with very high efficiency approaching black body absorption rates >90%. Heated fluid provides a temperature bath that can be used in a Stirling engine where the engine efficiency is determined by the difference in the hot and cold temperature baths, divided by the temperature of the high temperature bath. This efficiency is the same as for the Carnot cycle used in internal combustion engines, and efficiencies of >50% can be reached with modest temperature baths. For example, when operating a Stirling engine between 400° C. and 4° C. using a mixture of ammonia and water a theoretical efficiency of 58.5% is feasible. This theoretical value is reduced to 42% taking into account regeneration losses in the Stirling cycle. This number would be further reduced by 5% or so taking into account electrical generation losses.

To generate the required 400° C. a solar collection area of 150 square feet is needed, well within the range of a typical US home of 3000 square feet. The Stirling engine can also provide domestic hot water needs through the use of a heat exchanger.

### Distinctive New Features

1. Combined gas electricity generation, gas heating and compressing of gas into CNG for transportation

2. An eco system of connected devices for home heating, home electricity provisioning, and transportation

3. A modular Stirling engine for home electricity generation and auxiliary energy provisioning of electric transportation

4. A smart grid connecting energy eco-system homes to the grid. The smart grid may also be used to provide other home services such as medical care, remote control of vehicles and devices, and energy redistribution.

### Specific Advantages Are

1. A modular system that provides improved energy efficiency in transportation, requires relatively small amounts of investment by home owners, car owners and no new infrastructure is required for powering electric vehicles with auxiliary devices for battery charging to extend range.

2. By coupling a solar thermal system to the Stirling engine a complete sustainable solution is obtained that allows a consumer to drive an electric car, charge it at times when solar power is abundant and store the heat in the form of a liquid with a large thermal mass.

3. Use gas that is 25% cleaner than gasoline with applications when solar heating, or wind and water power generation are not available.

4. A modular Stirling engine that allows mass production at low cost and power configuration in respond to energy needs.

5. A complete home energy and transportation ecosystem.

6. A smart grid for regulation and efficient distribution of energy in the home and outside including making decisions based on economic and supply information.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. All such variations are considered to be within the scope and spirit of the present invention as defined by the following claims and their legal equivalents.

Further details, variations and embodiments are described in the attached APPENDIX A that includes 2-sheets of figures embodiments of the invention, and APPENDIX B that includes 26-sheets of description of embodiments of the invention.

What is claimed:

1. An energy system, comprising:
a. an engine, wherein said engine produces electricity;
b. a fuel storage, wherein said fuel storage holds fuel for use by said engine;
c. a battery, wherein said battery stores said electricity produced by said engine;
d. an electrical grid, wherein said electrical grid comprises electrical connectivity of a charging station from said engine or said battery; and
e. an electrical grid controller, wherein said electrical grid controller regulates the generation, use and delivery of said electricity to and from said electrical grid.
